(19) United States
(12) Patent Application Publication
(10) Pub. No.: US 2014/0167518 A1
(43) Pub. Date: Jun. 19, 2014

(54) Noise Isolator For a Portable Electronic Device

(71) Applicants: Clifford Risher-Kelly, Wells, ME (US); Charles LeMay, Portsmouth, NH (US); David C. Maurer, Stoneham, MA (US)

(72) Inventors: Clifford Risher-Kelly, Wells, ME (US); Charles LeMay, Portsmouth, NH (US); David C. Maurer, Stoneham, MA (US)

(21) Appl. No.: 14/233,439

(22) PCT Filed: Jul. 28, 2011
(86) PCT No.: PCT/US2011/045697

§ 371 Date: Jan. 17, 2014

(51) Int. Cl. H02M 1/44

(52) U.S. Cl. CPC H02M 1/44
USPC 307/89

(57) ABSTRACT

An apparatus for reducing noise in an electrical system includes a first isolation stage for a patient monitoring system that provides a first power transformation and a first isolation barrier to current flow. The patient monitoring system including a portable patient monitoring device, a charging apparatus that charges the portable patient monitoring device and a power supply that provides power to the charging apparatus and the first isolation stage is connected to the power supply. A second isolation stage is electrically connected between the first isolation stage and the charging apparatus. The second isolation stage provides a second power transformation and a second barrier to current flow, the second isolation stage reduces noise in the electrical system caused by stray currents.

### FIELD OF THE INVENTION

This invention concerns a system and method for reducing common mode noise in a portable electronic device.

### BACKGROUND OF THE INVENTION

Monitoring patients presents challenges to healthcare professionals that are charged with patient care. These challenges are accentuated when the patients being monitored are ambulatory because the devices used for monitoring patient parameters are also required to be movable so that the patient is not confined to a particular bed in a particular care unit. There are a plurality of different types of portable patient monitoring devices that are able to monitor different patient parameters. In order for these monitors to remain portable and enable patients to be ambulatory, these monitoring devices often include rechargeable batteries. In the field of ECG measurement, telemetry and portable patient monitors are popular alternatives for ambulatory patients. Most of today's monitors are built with rechargeable batteries that are typically placed in a suitable charger while the patient is still being monitored. However, a drawback associated with portable patient monitors is that, when docked for recharging, the signal being acquired from the patient by the monitoring device may be significantly degraded due to common mode currents that are converted to normal mode voltages.

An example of this common drawback is shown in FIG. 1 which depicts a patient being monitored using a portable electrocardiogram (ECG) monitor. A patient 10 is coupled to a portable ECG monitor 12 via ECG leads 14A-C. It is well known that in an ECG monitoring procedure, electrodes are placed on a patient's skin, and lead wires (leads) connect the electrodes to a patient monitoring device. As shown herein, the portable ECG 12 is docked in a charging cradle 16 which charges a battery within the portable ECG 12. The charging cradle 16 is coupled to and powered by a medical grade (low leakage) power supply 18. The medical grade, low leakage power supply 18 provides safety isolation and converts the AC power to a low voltage (e.g. low voltage DC). The power is delivered through the charging cradle 16 into which the portable monitor 12 is docked. The low voltage power selectively recharges the battery in the portable ECG 12. Inevitably, there is some capacitance bridging the isolation barrier in the power supply. These capacitances are stray capacitances and may result intentionally from the design of the device or may be parasitic, originating from the shape and geometry of the device. Additionally, there may be stray capacitances coupling the patient to his environment. A first stray capacitance 20 may be the result of the design of the power supply and enter the path of current at the point where the power supply 18 is coupled to the charging cradle 16. A second stray capacitance 22 is shown coupling the patient 10 to his/her environment. These stray capacitances 20, 22 form a current loop and couple the patient to the local ground plane. Thus, the current represented by the dotted arrow 24 flows through the charging cradle 16, patient monitor 12 through the ECG leads 14 into the patient 10 and to the ground via stray capacitance 22. A problem results from the current flowing through the ECG leads 14 as it causes the quality of the ECG signals to be significantly degraded. This is due to common mode currents which are converted to normal mode voltages when they are forced to flow through mismatched impedance connections of ECG electrodes to the body.

FIG. 2 represents a second scenario whereby common mode noise disrupts the monitoring capability of a portable ECG monitor. The setup shown in FIG. 2 mirrors the setup described in FIG. 1 with one important difference. In FIG. 2, the second stray capacitance coupling the patient 10 to their environment provides a pathway for noise or other interference to enter the circuit. For example, common mode noise and interference may be generated by the lights in the patient's room and/or the motors that are powering various medical treatment apparatuses used in providing the patient 10 with medical care (or possibly by direct connection in the case of another medical device). This noise voltage finds a current path back through the charger 16 and to ground through stray capacitance 20 which couples the input cable to ground. These sources of noise cause currents to flow in the patient connected ECG leads simultaneously and will disrupt the desired signal integrity.

A portable monitoring device is often used to monitor a patient who has an implanted pacemaker, many times immediately after surgery. Pacemakers generates pacer pulses in order to control the patient's heartbeat. It is necessary for the monitoring device to determine the time of occurrence of a pacer pulse, so as not to incorrectly treat the pulse as a feature of the actual ECG signal. Thus, a portable monitoring device must be able to correctly identify pacer pulses, while not mistakenly identifying noise features as pacer pulses. While conventional portable monitoring devices are able to reject low frequency interference, these devices are unable to effectively reject higher frequency harmonics that can easily be mistaken for pacer signals in practice thereby severely limiting the portable monitor's usefulness when the monitor is docked in a charging cradle. A system according to invention principles addresses deficiencies of known systems to improve cardiac condition detection.

### SUMMARY OF THE INVENTION

In one embodiment, an apparatus for reducing noise in an electrical system is provided. The apparatus includes a first isolation stage for a patient monitoring system that provides a first power transformation and a first isolation barrier to unintended current flow. The patient monitoring system including a portable patient monitoring device, a charging apparatus that charges the portable patient monitoring device and a power supply that provides power to the charging apparatus and the first isolation stage is connected to the power supply. A second isolation stage is electrically connected between the first isolation stage and the charging apparatus. The second isolation stage provides a second power transformation and a second barrier to current flow, the second isolation stage reduces noise in the electrical system caused by stray currents.

In another embodiment, a system for reducing noise in a patient monitoring environment is provided. The system includes a rechargeable portable patient monitoring device including a plurality of leads selectively connected to a patient and a charging dock that selectively receives and charges the rechargeable portable patient monitoring device. A power supply is provided for powering the charging dock and a noise isolator connected between the power supply and the charging dock for reducing noise caused by stray currents.

Another embodiment provides a method for reducing noise in a patient monitoring system by converting power from AC to DC using a first isolation stage and forming a first isolation barrier to stray capacitance using the first isolation stage. A DC to DC power conversion is performed using a second isolation stage that has a capacitance below a threshold value thereby forming a second isolation barrier to stray capacitance using the second isolation stage. Noise in the patient monitoring system caused by stray currents is reduced using the low capacitance of the second isolation stage.

### BRIEF DESCRIPTION OF THE DRAWINGS

FIG. 1 depicts a prior art setup of portable monitoring device being recharged;

FIG. 2 depicts a prior art setup of portable monitoring device being recharged;

FIGS. 3A-3B are exemplary embodiments of a noise isolation apparatus according to invention principles;

FIG. 4 is a circuit diagram of a noise isolation apparatus according to invention principles;

FIG. 5 is a circuit diagram illustrating how the noise isolation apparatus operates according to invention principles;

FIG. 6 is a circuit diagram illustrating how the noise isolation apparatus operates according to invention principles;

FIGS. 7A and 7B are a graphical comparisons of the prior art and the noise isolation apparatus according to invention principles;

FIGS. 8A and 8B are a graphical comparisons of the prior art and the noise isolation apparatus according to invention principles; and

FIG. 9 is a flow diagram detailing the operation of the noise isolation apparatus according to invention principles.

### DETAILED DESCRIPTION

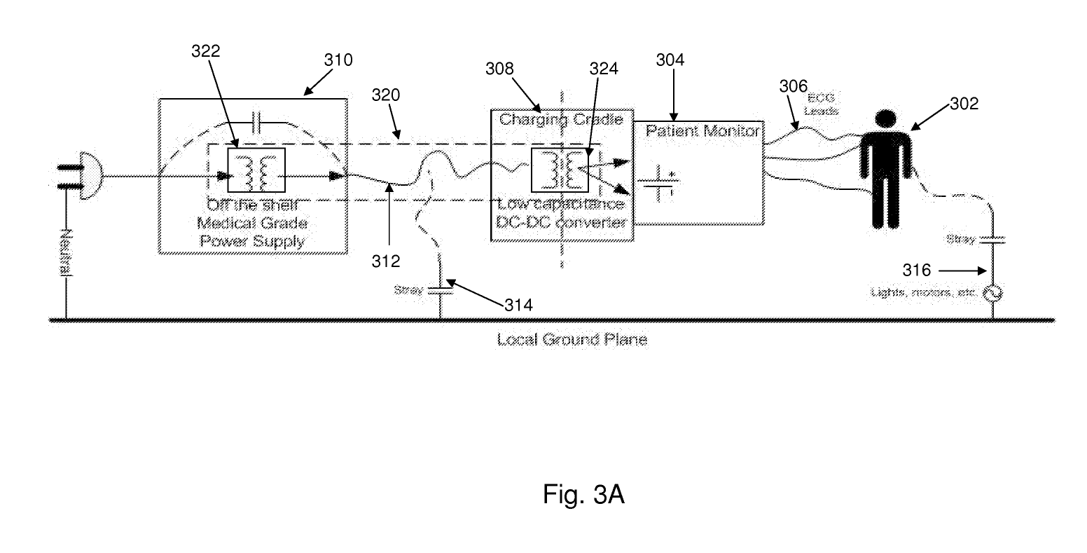

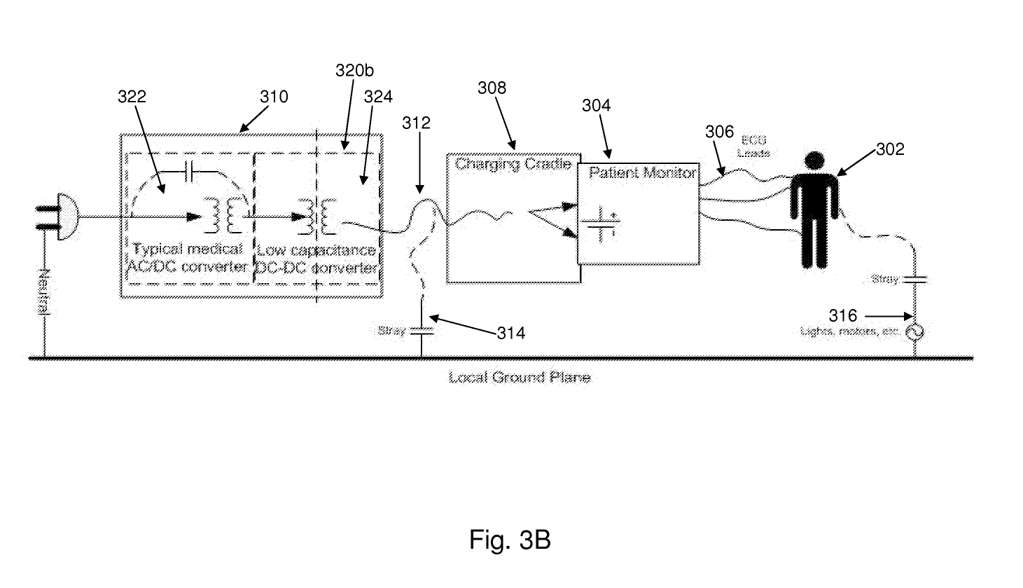

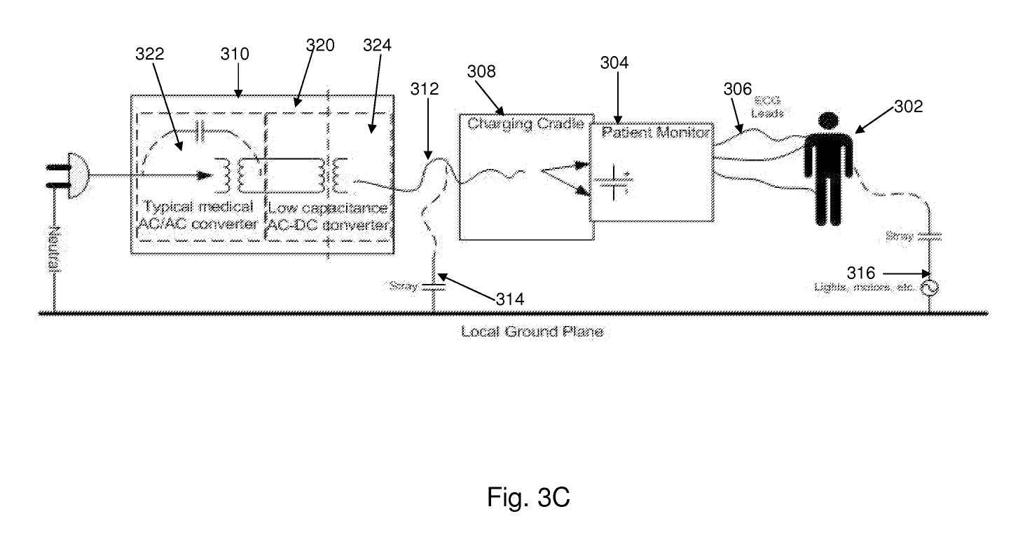

A noise isolator for a portable electronic device is shown in FIG. 3. The noise isolator advantageously provides a solution that significantly reduces the ability of an undesired current loop from forming. By minimizing or eliminating undesired current loops, the noise isolator reduces common mode interference. The reduction in common mode noise advantageously improves the integrity of a signal being monitored by the portable electronic device. The noise isolator reduces the common mode noise by using a very low capacitance patient barrier that provides a high impedance path to the undesired parasitic current.

An exemplary noise isolator is shown in FIG. 3A which depicts a patient monitoring setup. The patient monitoring setup of FIG. 3A depicts a patient 302 coupled to a patient monitoring device 304 via electrical leads 306. In one embodiment, the patient monitoring device 304 is a portable rechargeable ECG monitor and the electrical leads 306 are ECG leads that are connected directly to the patient 302 in any of a plurality of known ECG monitoring configurations. The portable monitor 304 selectively monitors at least one patient medical parameter of the patient 302. An exemplary patient monitoring device may include a device able to provide continuous standalone monitoring of a patient and be connected to at least one of a central monitoring station and a healthcare information system via a wired and/or wireless communications network. The patient monitoring device may be able to selectively monitor and process for display to a user at least one of (a) ECG data; (b) ST segment data; (c) pulse oximetry data and (d) other telemetry data Other portable patient monitors may measure at least one of (a) blood pressures (both invasive and non-invasive); (b) respiration gases (e.g. CO2, FiO2, anesthetic agents); (c) blood gases (e.g. O2, CO2); (d) patent temperature and (e) patient respiration. These parameters may be monitored by any of (a) oximetry monitors; (b) anesthesia monitors; (c) EEG (Electroencephalography) monitors and (d) BIS (Bispectral index) monitors

The portable patient monitoring device 304 enables the patient 302 to be ambulatory and move about a patient care unit in, for example, a hospital or other healthcare environment. When the patient is ambulatory, the patient monitoring device 304 is powered by a rechargeable battery. During the times that the patient is not ambulatory, the portable patient monitoring device 304 is selectively docked to a charging cradle 308. When docked in the charging cradle 308, the rechargeable battery of the portable patient monitoring device 304 is selectively charged, thereby enabling disconnection thereof and further ambulation of the patient at a later time. While docked in the charging cradle 308, the portable patient monitoring device 304 may, if still connected to the patient, continuously monitor the patient 302. The charging cradle 308 is coupled to a power supply 310 via an input cable 312. The power supply 310 may be a medical grade, low leakage power supply which provides safety isolation and translates power to a low voltage (typically low voltage DC).

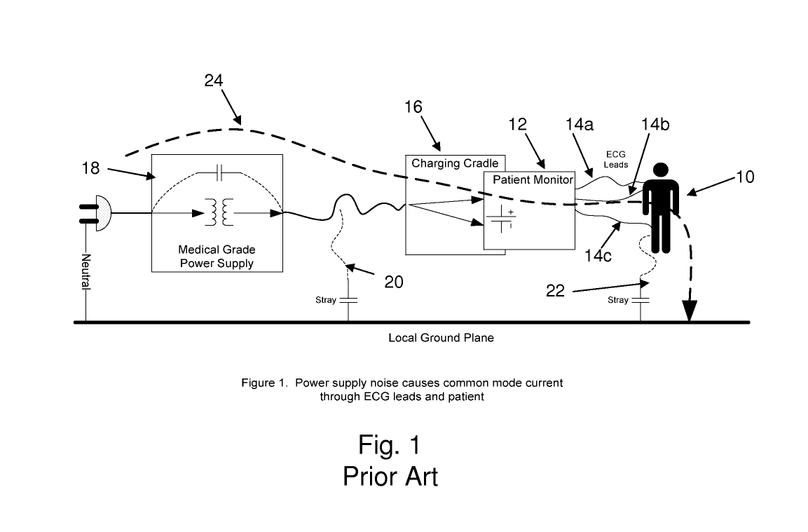

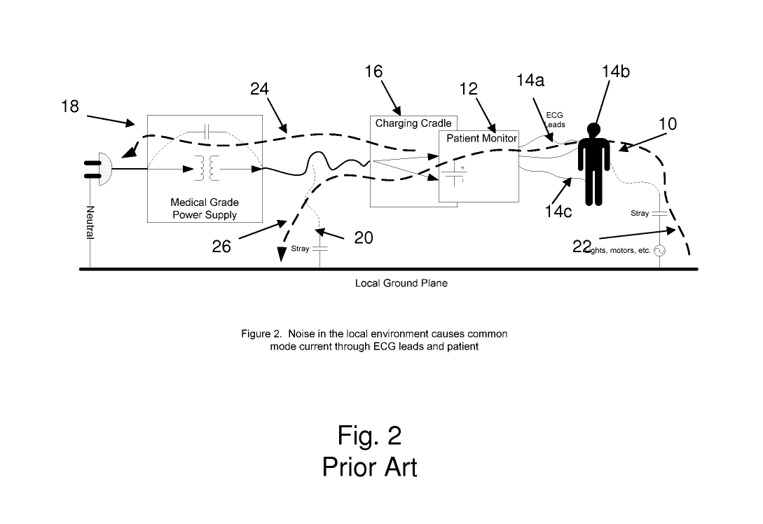

Typically, as discussed above in FIGS. 1 and 2, a first stray capacitance 314 and a second stray capacitance 316 selectively couple the patient to the local ground plane thereby completing a loop enabling a pathway for current generated from common mode noise to flow through the leads 306, into the patient 302 and to the ground plane. This common mode stray current may cause normal mode voltage noise due to an impedance imbalance in the patient applied electrodes. This results in the distortion of the signal being monitored by the leads 306. The first stray capacitance 314 may be at the input cable 312 that connects the power supply 310 to the charging cradle 308. The second stray capacitance may directly couple the patient 302 to the environment. This impedance imbalance introduces noise that corrupts the signal being monitored by the portable patient monitoring device 304 and the data being output by the portable patient monitoring device.

A noise isolator 320 in conjunction with a power supply 310 and the charging cradle 308 and provides a bather to reduce common mode voltages which prevents the flow of undesired current. The noise isolator 320 includes a two-stage power converter. The first stage is an AC-DC power converter 322 that complies with conventional medical isolation standards. The second stage power converter may be a DC-DC power converter 324 with a low capacitance (e.g. 5-10 pf) that selectively reduces the common mode voltage across an isolation barrier. An exemplary second stage power converter embodied in the noise isolator 320 may use a pot core design that includes a plurality of windings that are spaced apart on the inside of the core thereby achieving isolation of substantially 4000 volts. The inclusion of this second stage isolator advantageously places an additional very low capacitance patient barrier which adds impedance to the loop necessary for any current flow. By adding impedance to the current loop, common mode voltages are impeded from flowing through high impedance connectors (e.g. ECG leads) and being translated into normal mode voltages which would interfere with an output of the signal being monitored by the portable patient monitoring device 304.

FIG. 3A shows one embodiment of the noise isolator 320 whereby the first stage isolator is positioned in the power supply 310 and the second stage isolator is positioned in the charging cradle 308. This configuration advantageously provides further isolation from interference because the second stage isolator is positioned downstream from the input cable 312 which connects the charging cradle 308 to the power supply 310. Thus, any noise entering the system via stray capacitance 314 and which may generate a current would be blocked from flowing through the charging cradle 308 by the second stage isolator. Additionally, the second stage isolator further blocks any current originating from the second stray capacitance 316. The current may attempt to flow through the patient 302 and into the portable patient monitoring device 304 via the leads 306 but would be blocked by the second stage isolator in the charging cradle and thus prevented from completing a loop via the first stray capacitance 314.

An alternative embodiment of the noise isolator is shown in FIG. 3B. FIG. 3B includes certain similar elements that operate in a similar manner as those described above with respect to FIG. 3A. FIG. 3B depicts a patient 302 coupled to a patient monitoring device 304 via electrical leads 306. The portable patient monitoring device 304 is battery powered and enables the patient 302 to be ambulatory. The portable patient monitoring device 304 is selectively docked to a charging cradle 308 enabling the battery to be selectively recharged while simultaneously and continuously monitoring patient. The charging cradle 308 is coupled to a power supply 310 via an input cable 312.

The arrangement described with respect to FIG. 3B is susceptible to the first stray capacitance 314 and the second stray capacitance 316 that selectively couple the patient to the local ground plane thereby completing a loop enabling a pathway for current generated from common mode noise to flow through the leads 306, into the patient 302 and to the ground plane. The noise isolator 320b provides a barrier to reduce common mode voltages which prevents the flow of undesired current. The noise isolator 320b includes a two-stage power converter. The first stage is an AC-DC power converter 322b that complies with conventional medical isolation standards. The second stage power converter may be a DC-DC power converter 324b with a low capacitance (e.g. 5-10 pf) that selectively reduces the common mode voltage across an isolation barrier.

A further embodiment is shown in FIG. 3C which depicts an arrangement similar to the arrangement described above with respect to FIG. 3B. However, in this arrangement, a noise isolator 320c is shown having a two stage power converter. The first stage power converter 322c may be an AC-AC power converter that complies with conventional medical isolation standards. The second stage power converter 324c may be an AC-DC power converter that includes a low capacitance (e.g. 5-10 pf) that selectively reduces the common mode voltage across an isolation barrier.

The embodiments in FIGS. 3B and 3C include the noise isolator 320 formed integral with a single device such that the first and second stage isolators are present in series in the single device. This may occur, for example, in a charging apparatus that includes its own power supply and is able to translate AC to DC. These embodiments, similar to the one shown in FIG. 3A, advantageously disrupts any current loop from forming that may be owed to interference entering at the second stray capacitance point 316.

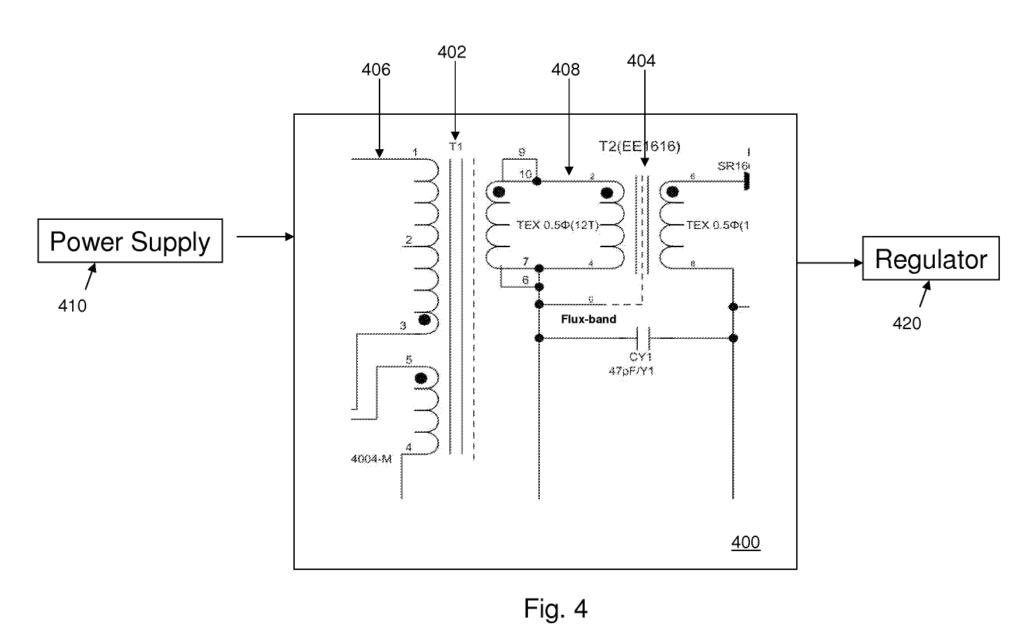

FIG. 4 represents an exemplary circuit diagram of a noise isolator 400 for use in reducing common mode noise from an electrical system. The noise isolator 400 provides a first voltage barrier 402 and a second voltage bather 404. The barriers are very low capacitance barriers and prevent common mode currents from being transferred therebetween. The two barrier configuration shown in FIG. 4 is accomplished by providing a first stage isolator 406 which may be a transformer that provides isolation in compliance with a medical isolation standard enabling the formation of the first barrier 402. Additionally, a second stage isolator 408 is provided and may be a transformer that results in the formation of the second barrier 404. In operation the noise isolator 400 is connected between an AC power supply 410 and a regulator 420 of a portable patient monitoring device. By using the low capacitance second stage isolator 408 in series with the first stage isolator 406, the noise isolator 400 is advantageously able to impede a current loop from being formed by common mode noise that enters a system via any stray capacitance.

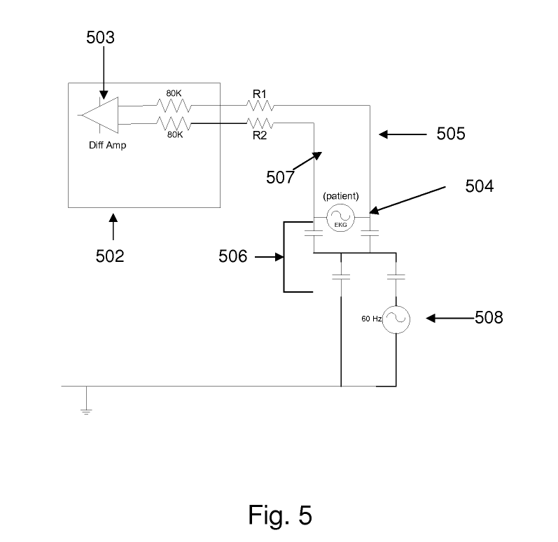

FIGS. 5-8 show how the noise isolator effectively limits the common mode noise from entering a patient monitoring setup. FIG. 5 depicts a monitoring scenario whereby a patient monitoring device is coupled to a patient and is floating relative to earth ground. Thus, the stray capacitance 506 shown herein represents the capacitance of the patient with the ambient environment. The exemplary circuit in FIG. 5 includes a portable patient monitoring device 502 having differential amplifier 503 for rejecting a 50 or 60 Hz common mode noise signal that is present at the inputs. In operation, this common mode noise signal may be incorrectly identified as a pace pulse. A “pace pulse” (also called “pacer pulse”) is a normal mode signal generated by a pace maker that is implanted in a patient. The portable patient monitor also records the time of occurrence of a pace pulse for further processing and displays a marker on the waveform of the monitored data to indicate the occurrence of a pace pulse.

A patient 504 is connected by a first lead 505 and a second lead 507 to the portable patient monitoring device 502. As shown herein, the patient 504 is represented by a voltage generator 504 that selectively generates voltages for monitoring by the patient monitoring device 502 as is commonly known. The patient 504 is shown coupled to the ground via capacitances 506 which allow for entrance of common mode noise 508 into the circuit. Common mode noise 508 is shown for purposes of example as a voltage generator that generates a 50 or 60 Hz signal which would contains spikes that would be incorrectly identified by the patient monitoring device 502 as described above

The first lead 505 and second lead 507 may be representative of respective ECG leads that have respective impedances associated therewith. The respective impedances are represented by resistors R1 and R2 on first lead 505 and second lead 507, respectively. Common mode noise signal 508 enters the system, flows through the patient 504 and through one of the respective leads 505 or 507. If the impedance values of R1 and R2 are equal, then common mode noise currents of equal amplitudes will flow through the respective leads 505 or 507; in the case of an impedance imbalance between R1 and R2, different amounts of current flow through each of the respective leads 505 or 507. The differential amplifier 503 in the patient monitoring device amplifies a differential signal and rejects the common mode signal when the impedance values of R1 and R2 are equal. The problem arises when the imbalance of impedance over R1 and R2 reaches or surpasses a threshold value thereby preventing the differential amplifier 503 from correctly rejecting common mode noise signals. A typical operating range of R1 and R2 impedances is 0 to 15 Mohm. A newly applied electrode, if applied correctly, will result in an impedance value of 0 to 50 Kohm. After a period of time, the impedance may degrade due to drying of the electrode gel to between 300 Kohm and 1 Mohm, resulting in an impedance balance. An exemplary threshold for noise caused by imbalanced input ranges between substantially 300 Kohm and 400 Kohm Table 1 shows various impedance values for R1 and R2 and the differential at which the portable patient monitoring device 502 would be unable to properly reject a pace pulse signal caused by common mode noise 508.

TABLE 1
Noise seen due to imbalance when not the charger

| R1 | | R2 | | Noise |
|---|---|---|---|---|
| 0 | | 0 | | Not Detected |
| 300 | Kohm | 0 | | Detected |
| 300 | Kohm | 300 | Kohm | Not Detected |
| 1 | Meg | 1 | Meg | Not Detected |
| 1 | Meg | 700 | Kohm | Detected |

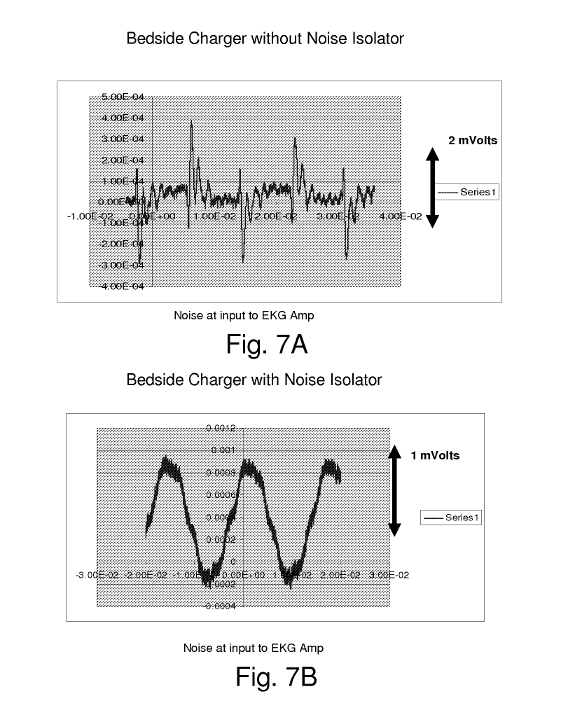

Table 1 shows that when the impedance values are equal there is no common mode noise detected by the patient monitor irrespective of the resistance value across the respective resistor. However, once the resistance difference between R1 and R2 is equal at least 300 K Ohm, significant noise is converted into a differential signal, thus noise may be incorrectly identified as a pace pulse. When there is significant noise detected, too many signals are determined to be pace signals. This false determination of pace signals is output as a plurality of spikes (see FIG. 7A) which results in the data being unusable.

The noise isolator, as discussed above with respect to FIGS. 3 and 4, provides a two stage isolator having a low capacitance that reduces common mode noise from entering the system via any stray capacitances 506. The reduction in common mode noise reduces the likelihood that the differences in impedance values between R1 and R2 would reach the threshold noise differential. Moreover, the number of signals reaching the threshold value will decrease, thereby advantageously enabling the differential amplifier 503 of the patient monitoring device 502 to properly identify, record and display the occurrence of pace pulse signals as intended and reduce the instances of the patient monitoring device 502 having monitored data consisting of artificial pacer signals.

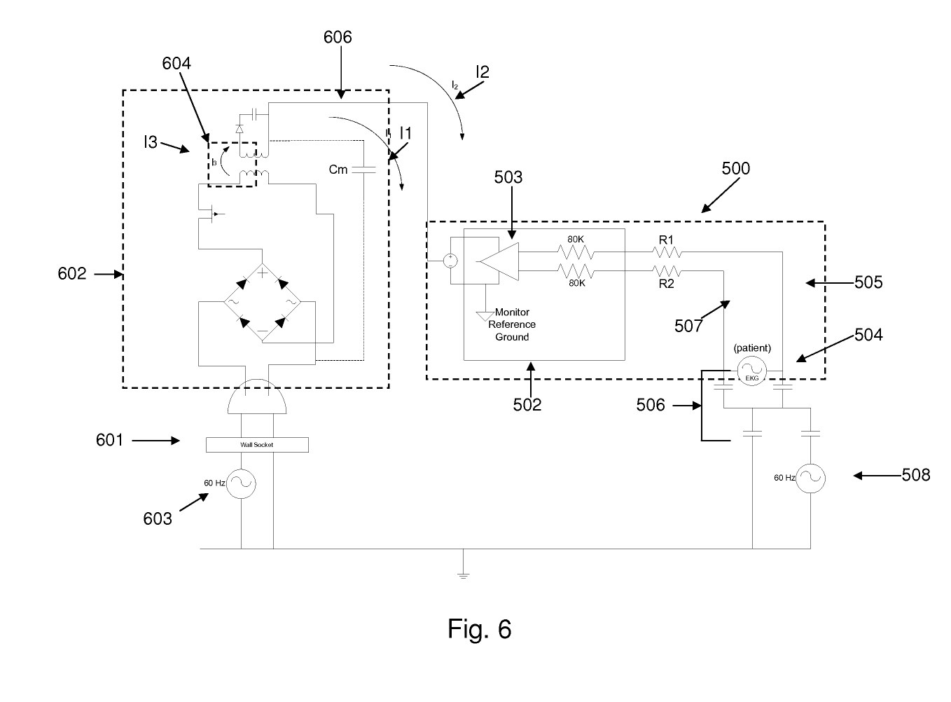

Another instance during which the inclusion of the noise isolator would be advantageous will described in conjunction with the circuit diagram of FIG. 6. FIG. 6 is a circuit diagram including the circuit described above with respect to FIG. 5 representing the portable patient monitoring device 502 for monitoring the patient 504 whereby all like elements are represented by the same reference numerals. FIG. 6 is a circuit representation of the portable patient monitoring device 500 docked within a charging cradle 602. The charging cradle 602 is coupled to a power supply 601 for providing power thereto. The charging cradle 602 further includes a transformer 604 that provides a single stage isolation by converting AC to DC. The charging cradle 602 is coupled to the portable patient monitoring device 502 via connection 606. While connection 606 is shown herein as a wire, one skilled in the art will recognize that there are many known manners by which the two devices may be electrically connected and that the connection 606 may take the form of any known electrical coupling between devices.

Similarly, as described above with respect to FIG. 5, an imbalance in impedances between R1 and R2 prevents the differential amplifier 503 from effectively rejecting common mode noise. However, when connected in the charging cradle 602, the impedance differential resulting in ineffective discrimination begins at a lower threshold value. Additionally, this configuration provides a second different source of common mode noise signal. When the portable patient monitoring device 502 is docked in the charging cradle 602, the second source of common mode noise is generated by the charger power supply. Specifically, the transformer 604 enables a 50 or 60 Hz common mode noise signal 603 to be present on the supply voltage. The design of this supply is not adequate and allows 50 or 60 Hz current signal to be present on the supply voltage which may be generated by leakage in the transformer 604. This stray current is represented as I3. This unwanted current I3 is cancelled by two components. Current I3 is divided into two currents I1 and I2, I1 flows to Capacitance (Cm) across the isolation barrier results and the remaining current I2 flows across connection 606 into the portable patient monitoring device 502 and through the first and second leads 505 and 507, respectively. As I2 is split between R1 and R2, a differential voltage at the input of the amplifier is developed whose magnitude is proportional to the imbalance of R1 and R2. The imbalance performance is shown in Table 2.

TABLE 2
Noise seen in standard charger

| R1 | | R2 | | Noise |
|---|---|---|---|---|
| 0 | | 0 | | Not Detected |
| 32 | Kohm | 0 | | Detected |
| 32 | Kohm | 32 | Kohm | Not Detected |
| 1 | Meg | 1 | Meg | Not Detected |
| 1 | Meg | 700 | Kohm | Detected |

The relationship between I2 and the ability to tolerate an imbalance at the input can be seen from Table 3. As shown in Table 3, Cm represents the capacitance across the isolation barrier responsible for accepting some of the unwanted current I3.

TABLE 3
Impedance imbalance in a charger which results in detected noise and
associated leakage as a function of the increased impedance.

| | | R1 Threshold | | | | | |
|---|---|---|---|---|---|---|---|
| Cm | | of detected noise. | | R2 | Leakage | | IEC Requirments. |
| 0 | pf | 32K | ohm | 0 | 0 | uAmps | Acceptable |
| 100 | pf | 75K | ohms | 0 | 10 | uAmp | leakage level |
| 270 | pf | 169K | ohm | 0 | 30 | uAmp | Unacceptable |
| 520 | pf | 385K | ohm | 0 | 500 | uAmp | leakage level |
| 1000 | pf | 5M | ohm+ | 0 | 1000 | uAmp | |

An increase in the value of Cm may also represent an increase in the value of I1 and a proportional decrease in the value of I2 that flows through connection 606 and into the portable patient monitoring device. As I1 increases, I2 decreases and allows a greater imbalance between R1 and R2 before significant noise is developed and detected by the differential amplifier 503 of the portable patient monitoring device 502. However, one cannot merely increase the capacitance (or value of I1) in a patient monitoring device because I1 is limited to 10 μAmps for patient safety. As I2 is unable to be reduced proportionally by increasing the value of I1, I2 may be reduced by reducing the source of interference I3.

The noise isolator of FIGS. 3 and 4 advantageously enables the reduction of I2 by reducing the value of interference I3. The second stage isolator advantageously employs a very low capacitance DC-DC converter thereby providing a second isolation barrier, reducing the value of current I3 flowing through the circuit. Employing the noise isolator advantageously controls the leakage current and reduces the noise source for pace pulse detection. This further reduces the undesirable output by the patient monitoring device of a plurality of pace pulse spikes that are not physiologically caused and thereby medically irrelevant with respect to the patient.

FIGS. 7A and 7B are graphs comparing the performance of a device that does not include the noise isolator with a device that does include the noise isolator. FIG. 7A is a graph showing noise at the input to the differential amplifier in a charging cradle that does not include the noise isolator such as those discussed above with respect to FIGS. 1 and 2. FIG. 7A shows a plurality of sharp spikes that are generated in response to the 60 Hz common mode noise signal that entered the circuit via a stray capacitance between the patient and the ground plane, for example. These sharp spikes are misinterpreted as pace pulses which should be eliminated prior to being output by the monitor. With the new charger, the detection generation of noise which causes false pace pulses due to the 60 Hz noise is eliminated. FIG. 7B represents noise input to a charging cradle that includes the noise isolator such as those discussed above with respect to FIGS. 3 and 4. In the charging cradle with the noise isolator, the detection of the pace pulses from a 60 Hz common mode noise signal is reduced. As a result, the detection of the false pacer pulses is eliminated. This occurs because the amplitude of the noise is reduced sufficiently to prevent the noise from being improperly identified as pacer pulses. The resulting graph shows only the low frequency 60 Hz signal

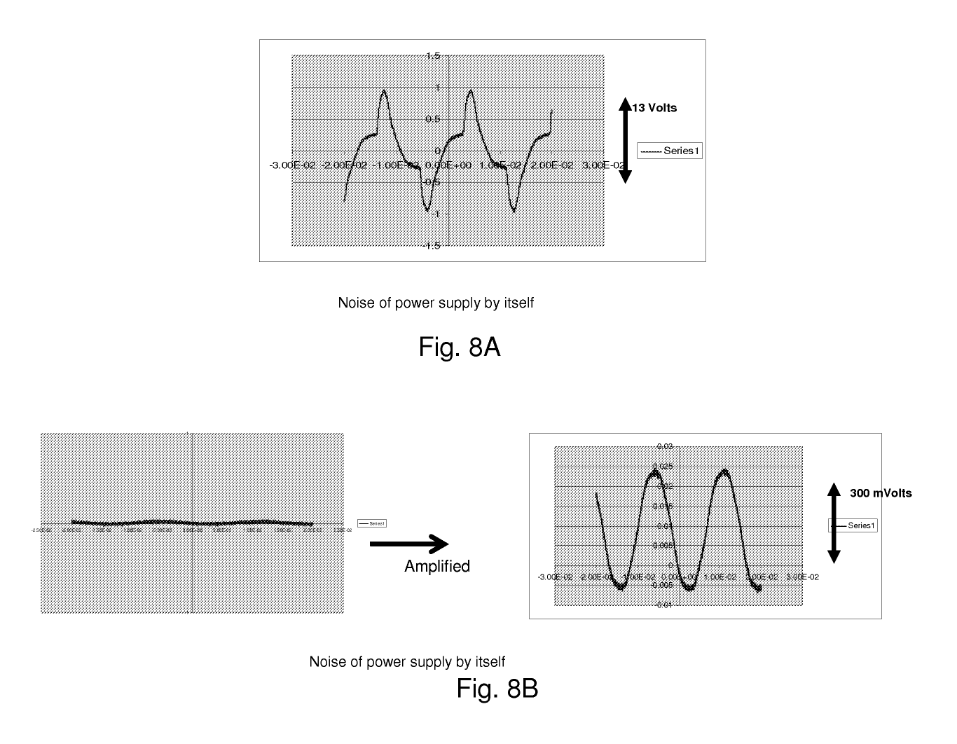

FIGS. 8A and 8B are graphs comparing the performance of a device that does not include the noise isolator with a device that does include the noise isolator with respect to the output of noise at the respective power supplies. The graphs of FIGS. 8A and 8B depict the actual output of the charging cradle relative to earth ground. The measurements shown herein were acquired using a 10 Meg scope probe to ground and only the output of the power supply is measured against ground. FIG. 8A is the measurement at the output of the power supply in a device that does not include the noise isolator such as those described above with respect to FIGS. 1 and 2. A device without the noise isolator has a 13 volt signal due to the leakage in the device having only an AC-DC converter. FIG. 8B is the measurement at the output of the power supply in a device including the noise isolator such as those described above with respect to FIGS. 3 and 4. The noise of the power supply in the device including the noise isolator is 300 mVolts. Thus, the noise isolator with the first and second isolation stages provides an improvement of a substantially 43 times the noise reduction as compared to the device without the noise isolator. This results in an engineering improvement in devices having the noise isolator thereby allowing such devices to meet a specification for common mode leakage ranging substantially between 30 nAmps and 50 nAmps.

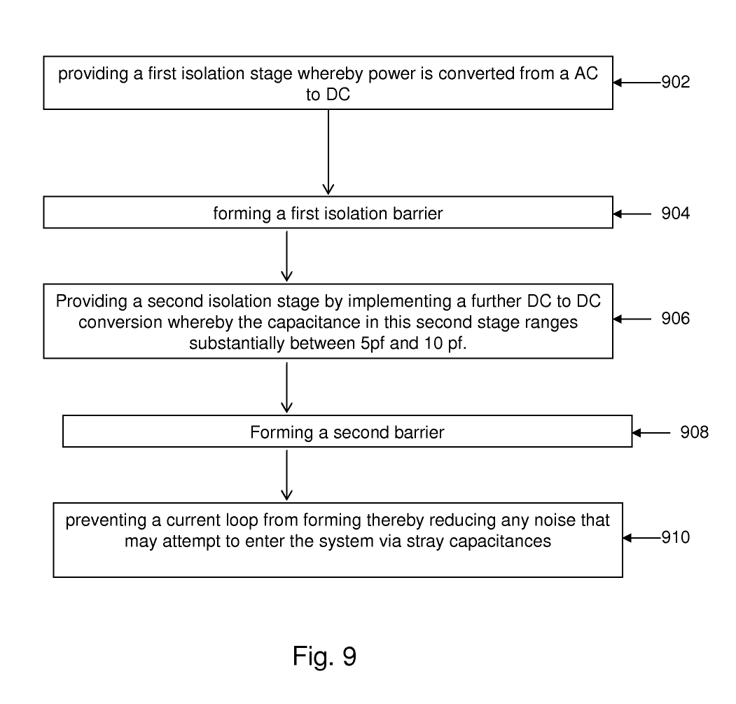

FIG. 9 is a flow diagram detailing the operation of the noise isolator within a patient monitoring scenario whereby a rechargeable portable patient monitoring device is coupled to a charging cradle. In step 902, a first isolation stage is provided whereby power is converted from a AC to DC and a first isolation barrier is formed in step 904. In step 906, a second isolation stage is formed by implementing a further DC to DC conversion whereby the capacitance in this second stage ranges substantially between 5 pf and 10 pf. The second isolation stage with the low capacitance results in a second barrier being formed in step 908. The inclusion of a first and second isolation stage prevents a current loop from forming in step 910 thereby reducing any noise that may attempt to enter the system via stray capacitances such as those coupling the charging cradle to a power supply and/or a stray capacitance that couples the patient to the ground plane. The very low capacitance of the second isolation stage provides an effective barrier and reduces the noise in the system thereby improving the quality of the signal being monitored by the rechargeable portable patient monitoring device during the activity of recharging.

The noise isolator having first and second isolation stages may be formed in any combination and configuration. In one embodiment, the first and second isolation stages may be formed integrally within a power supply from which a charging cradle obtains its power. In another embodiment, the first and second isolation stages of the noise isolator may be included in a charging cradle for charging a portable electronic device. In a further embodiment, the first isolation stage and second isolation stage may be positioned in different system components in order to maximize the barriers formed thereby, effectively preventing current loops from forming throughout a system. For example, the first stage isolator may be present in a power supply and the second stage isolator may be present in the charging cradle. In this configuration, the second isolation barrier effectively prevents current derived from a capacitance positioned between the power supply and the charging cradle from flowing through the leads connecting the monitoring device. This further provides the advantage of preventing current derived from the capacitance coupling the patient to the ground plane from flowing through the leads connecting the patient, through the monitor and back to ground via any other stray capacitance.

Although the invention has been described in terms of exemplary embodiments, it is not limited thereto. Rather, the appended claims should be construed broadly to include other variants and embodiments of the invention which may be made by those skilled in the art without departing from the scope and range of equivalents of the invention. This disclosure is intended to cover any adaptations or variations of the embodiments discussed herein.

What is claimed is:

1. An apparatus for reducing noise in an electrical system comprising:
a first isolation stage for a patient monitoring system that provides a first power transformation and a first isolation barrier to current flow, the patient monitoring system including a portable patient monitoring device, a charging apparatus that charges the portable patient monitoring device and a power supply that provides power to the charging apparatus, the first isolation stage is connected to the power supply;
a second isolation stage electrically connected between the first isolation stage and the charging apparatus, the second isolation stage provides a second power transformation and a second barrier to current flow, said second isolation stage reduces noise in the electrical system caused by stray currents.

2. The apparatus according to claim 1, wherein
said first isolation stage includes an AC to DC converter and a capacitor for receiving an interference current derived from leakage during said first power transformation.

3. The apparatus according to claim 1, wherein
said second isolation stage includes a DC to DC converter having a capacitance below a threshold value.

4. A system for reducing noise in a patient monitoring environment comprising:
a rechargeable portable patient monitoring device including a plurality of leads selectively connected to a patient;
a charging dock that selectively receives and charges the rechargeable portable patient monitoring device;
a power supply for providing power to the charging dock; and
a noise isolator connected between the power supply and the charging dock for reducing noise caused by stray currents.

5. The system according to claim 4, wherein
said noise isolator includes
a first isolation stage that provides a first power transformation and a first isolation barrier to current flow;
a second isolation stage that provides a second power transformation and a second barrier to current flow, said second isolation stage reduces noise caused by stray currents.

6. The system according to claim 4, wherein
said noise being reduced is common mode noise that enters the system via at least one stray capacitance.

7. The system according to claim 5, wherein
said first isolation stage of said noise isolator is connected to said power supply and said second isolation stage of said noise isolator is connected between said first isolation stage and said charging dock.

8. The apparatus according to claim 5, wherein
said first isolation stage includes an AC to DC transformer and includes a capacitor for receiving an interference current derived from leakage during said first power transformation.

9. The apparatus according to claim 5, wherein
said second isolation stage includes a DC to DC converter having a capacitance below a threshold value.

10. A method for reducing noise in a patient monitoring system comprising the activities of:
converting power from AC to DC using a first isolation stage;
forming a first isolation barrier to stray capacitance using the first isolation stage;
performing a DC to DC power conversion using a second isolation stage, the second isolation stage having a capacitance below a threshold value;
forming a second isolation barrier to stray capacitance using the second isolation stage; and
reducing noise in the patient monitoring system using the capacitance of the second isolation stage thereby reducing noise in the patient monitoring system caused by stray currents.

11. The method according to claim 12, wherein
said activity of converting using the first isolation stage occurs at a power supply and said activity of performing a DC to DC power conversion occurs at a charging cradle having a portable patient monitoring device docked therein.
